(19) United States
(12) Patent Application Publication
(10) Pub. No.: US 2008/0047540 A1
(43) Pub. Date: Feb. 28, 2008

(54) Grill top with removable rods

(76) Inventors: Steve Hoffman, Mahwah, NJ (US); Paul Webster, New York, NY (US); Robert E. Cannuscio, West Chester, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/879,625

(22) Filed: Jul. 18, 2007

Related U.S. Application Data
(60) Provisional application No. 60/831,817, filed on Jul. 18, 2006.

(51) Int. Cl. A47J 37/00

(52) U.S. Cl. 126/25 A

(57) ABSTRACT

A grill top for a grill, the grill including a wall and an open cooking area, the grill top adapted to be mounted to the grill such that the grill top extends across at least a portion of the grilling area. The grill top includes a grill frame having at least two opposed sides, and a plurality of grill rods. Each grill rod includes first and second opposed ends, the first end being rotatably mounted to one side of the grill frame and the second side being rotatably mounted to the other side such that each rod is rotatable relative to each adjacent rod and the grill frame. The grill rods are preferably removable for cleaning. Also disclosed are several devices for cleaning the grill rods.

### RELATED APPLICATION

The present invention is related to and claims priority from U.S. Provisional Application No. 60/831,817, filed on Jul. 18, 2006, the disclosure of which is incorporated herein by reference in its entirety.

### FIELD OF THE INVENTION

The present invention relates to grills and, more specifically, to an improved grill top that includes removable grill rods and associated cleaning devices.

### BACKGROUND

Conventional grills include a grill top or grate that has a series of rods welded or otherwise integrally attached to a frame so as to form a unitary cooking surface which positions the items being cooked at a select position over the cooking fire.

While there have been many advances in grills made over the years, the grill top itself has remained essentially unchanged.

As food cooks on a grill top, fats, food particles, oils and other cooking by-products accumulate on the surface of the grill rods. These items eventually become baked onto the grill rods, reducing the effectiveness of the metal rod to conduct heat to food being cooked. Thus, over time, it becomes necessary to clean or replace the entire grill top. Currently the process for cleaning the grill top involves scraping or scouring the rods. This is usually performed with a scouring pad or brush. This technique works fairly well, although does not result in cleaning of the entire rod surface. Food can and generally does become trapped or caked on the sides and at the ends of the grill rods. In many cases users opt to simply replace the grill top at the beginning of every cooking season.

A need exists for a more efficient grill top and cleaning system for reducing food build up on grill tops.

### SUMMARY OF THE INVENTION

The present invention relates to an improved grill top for a grill. The grill including a wall and an open cooking area. The grill top is designed to be mounted to the grill such that the grill top extends across at least a portion of the grilling area. The grill top includes a grill frame having at least two opposed side frames. A plurality of grill rods are provided. Each grill rod includes first and second opposed ends. The first end of each rod is rotatably mounted to one side frame and the second end is rotatably mounted to the other side frame such that each rod is rotatable relative to each adjacent rod and the grill frame. A variety of embodiments of the grill frame are disclosed.

Also disclosed are cleaning devices for scraping food remnants off the rods after grilling. The cleaning devices can be mounted to the grill frame or the grill. Alternatively, the cleaning devices can be hand-held devices which include a scouring pad for scarping the rods and a drive system for rotating the rods to facilitate scouring of all sides of the rods.

Other objects, aspects and advantages of the present invention will become apparent to those skilled in the art upon reading the following detailed description, when considered in conjunction with the appended claims and the accompanying drawings briefly described below.

### BRIEF DESCRIPTION OF THE DRAWINGS

For the purpose of illustrating the invention, the drawings show a form of the invention that is presently preferred. However, it should be understood that this invention is not limited to the precise arrangements and instrumentalities shown in the drawings.

FIG. 1 is a side view of one embodiment of a grill according to the present invention.

FIG. 2 is a partial top cross-sectional view of the grill taken along lines 2-2 in FIG. 1.

FIG. 3A is a partial side view of the grill of FIG. 2 illustrating one embodiment of a cleaning device according to the present invention.

FIG. 3B is a partial top cross-sectional view of the grill illustrating the embodiment of the cleaning device shown in FIG. 3A.

FIG. 4A is an isometric view of a grill top according to another embodiment of the invention.

FIG. 4B is a top view of the grill top of FIG. 4A.

FIG. 4C is a front view of the grill top of FIG. 4A.

FIG. 4D is an isometric view of the grill top of FIG. 4A illustrating the grill rods being slidably removed from the frame.

FIG. 5A is an isometric view of an alternate embodiment of a grill top according to the present invention.

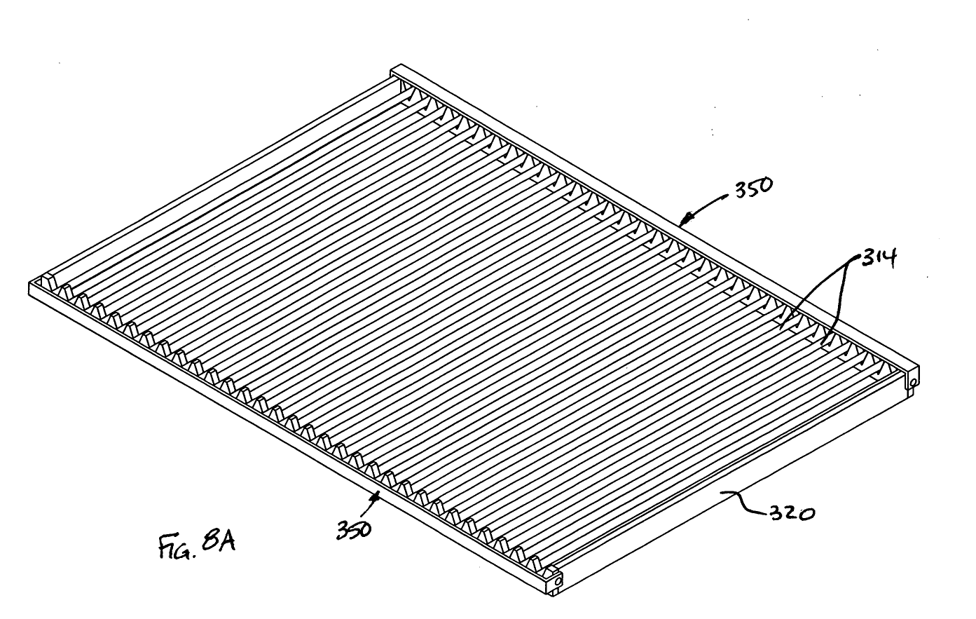

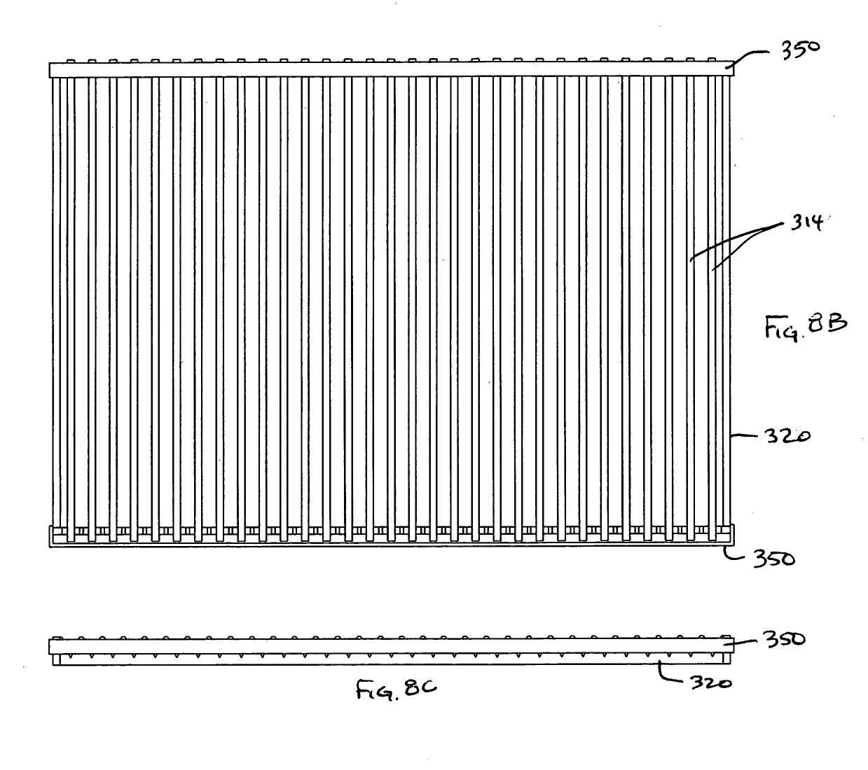

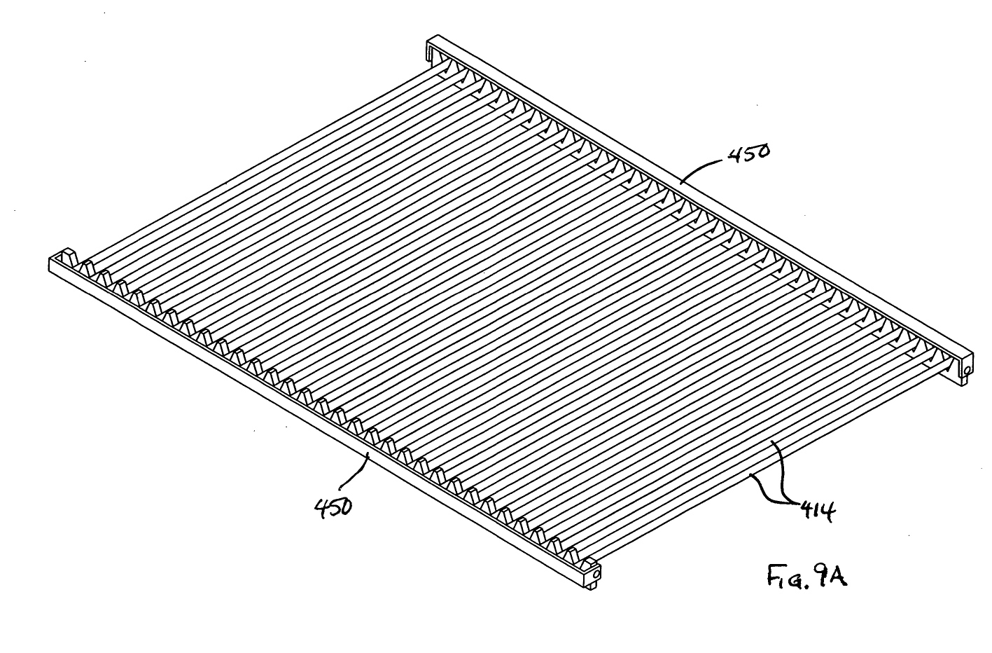

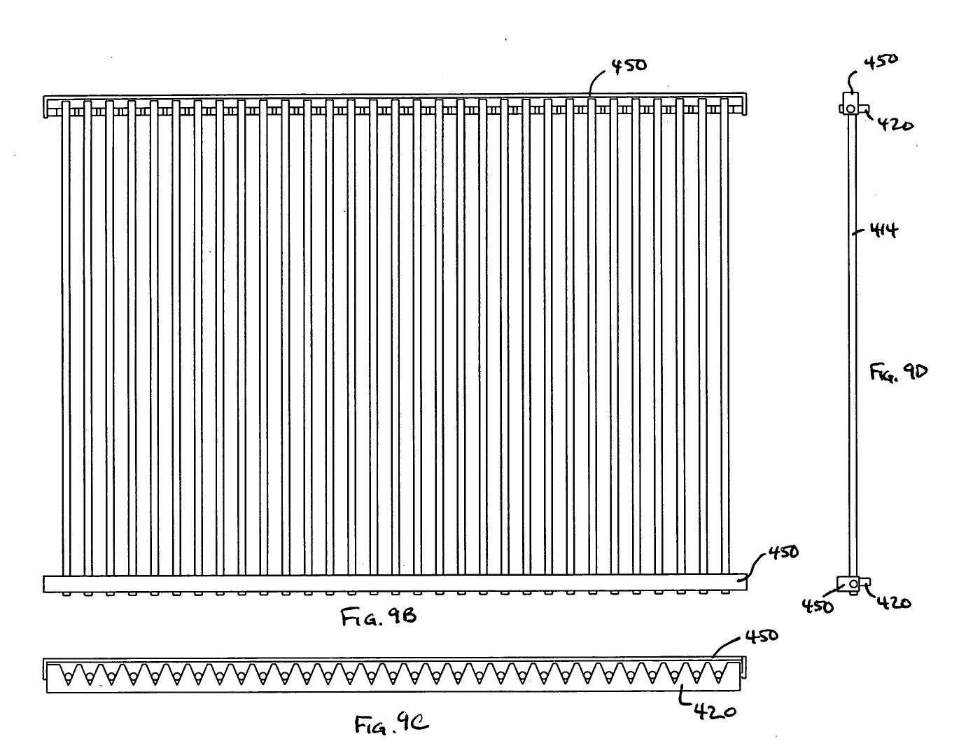

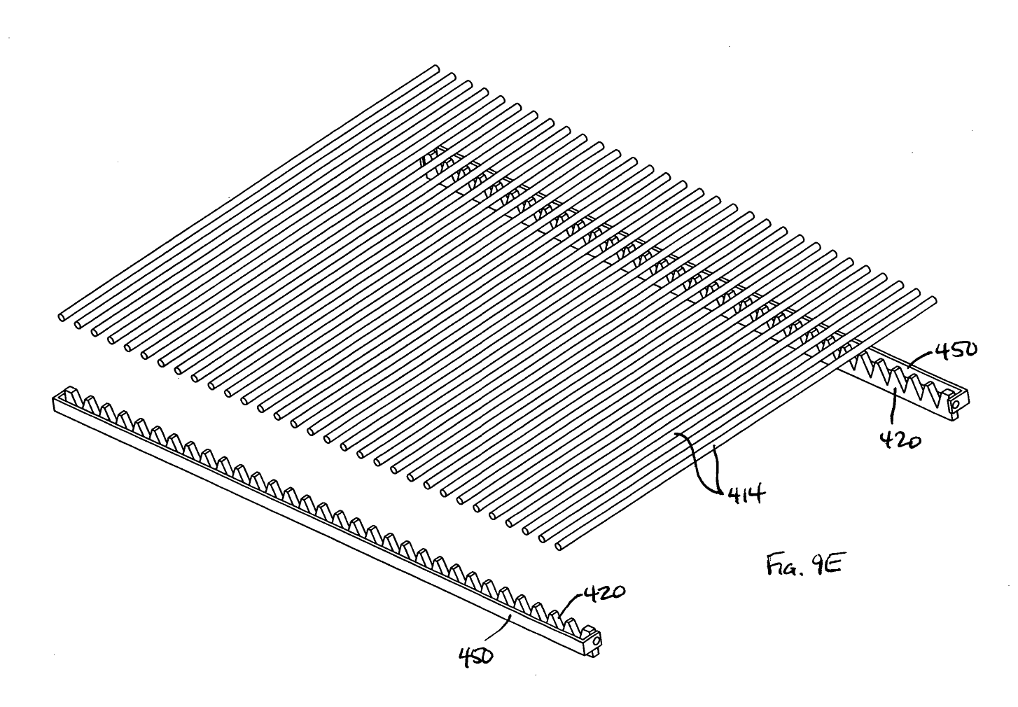

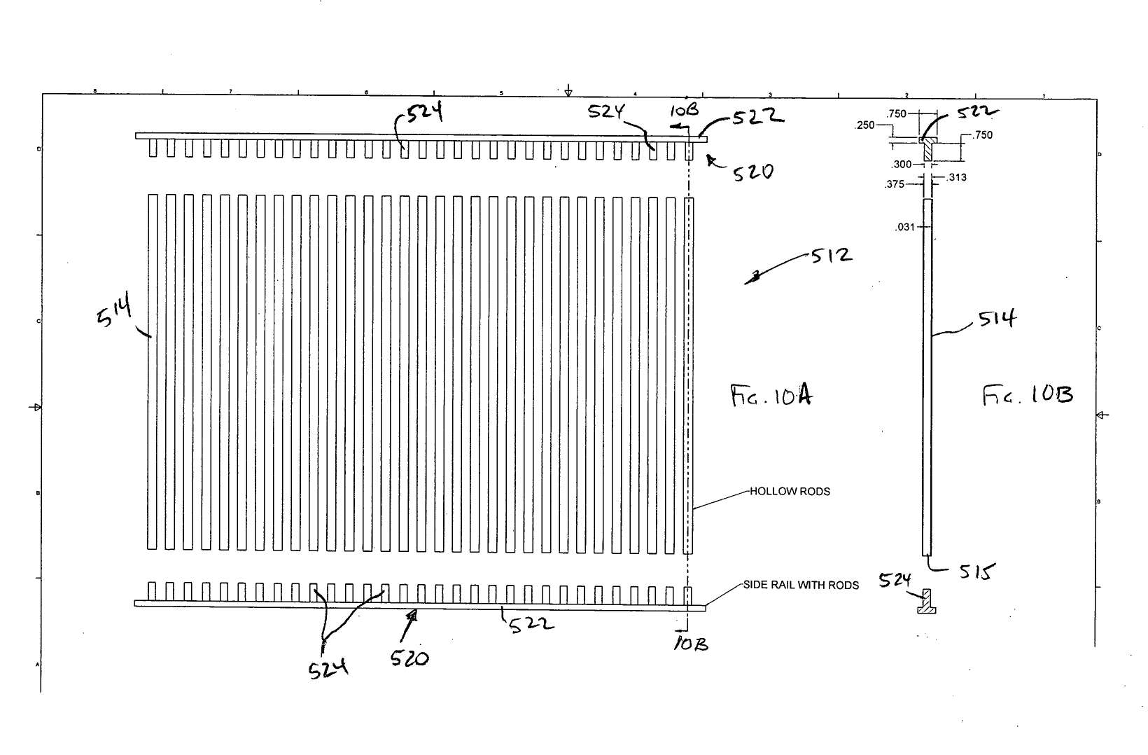

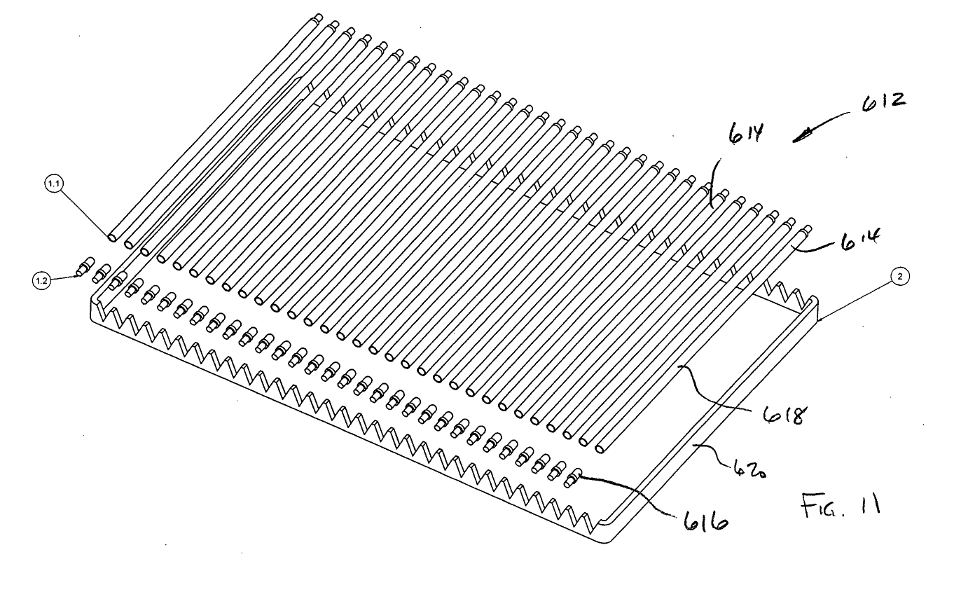

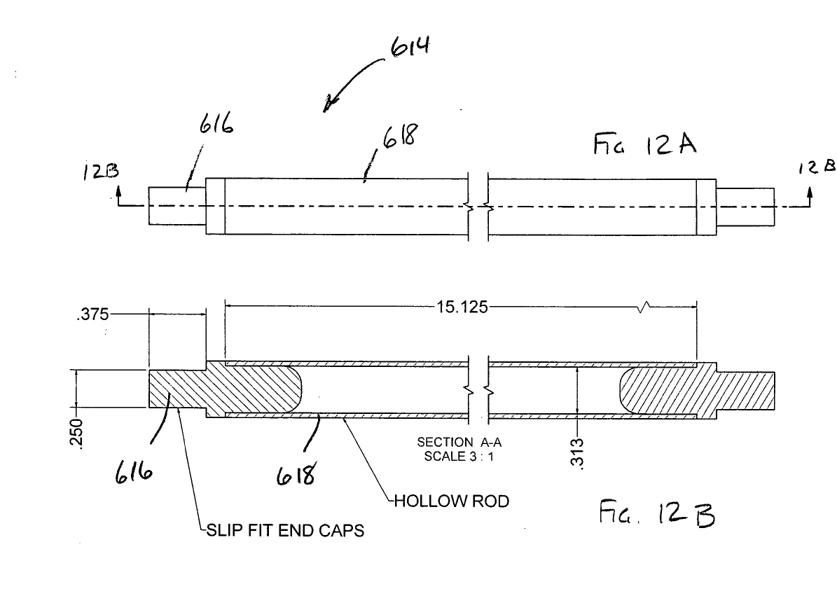

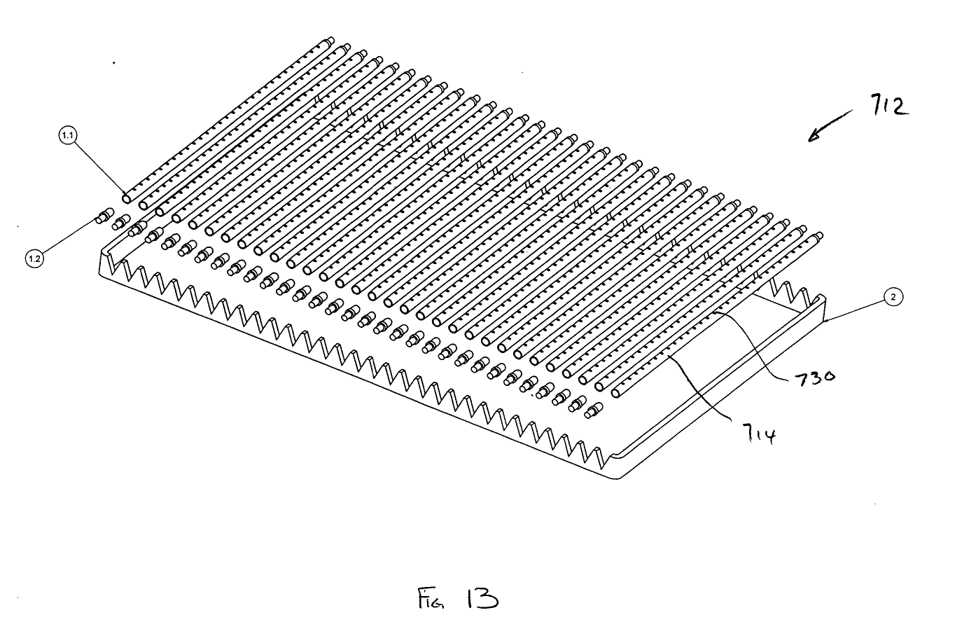

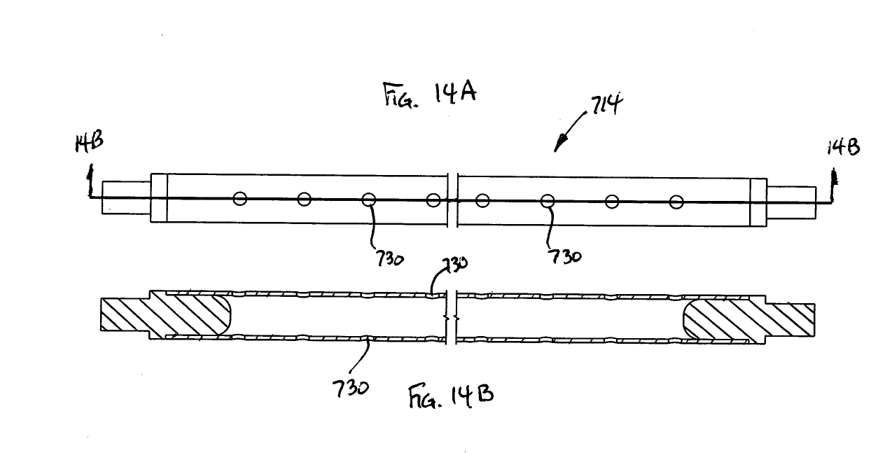

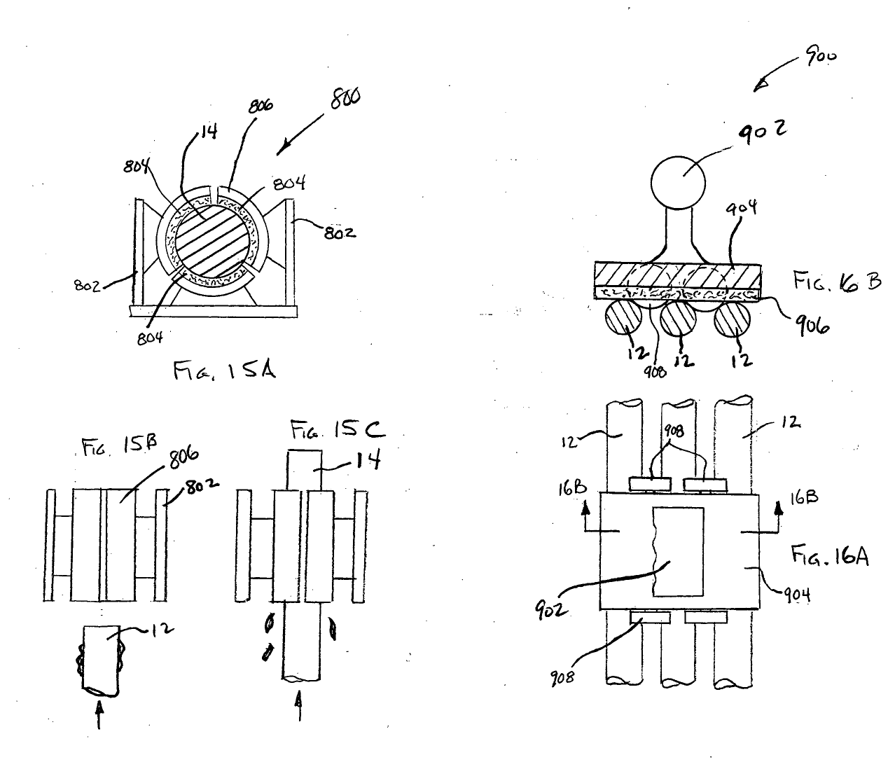

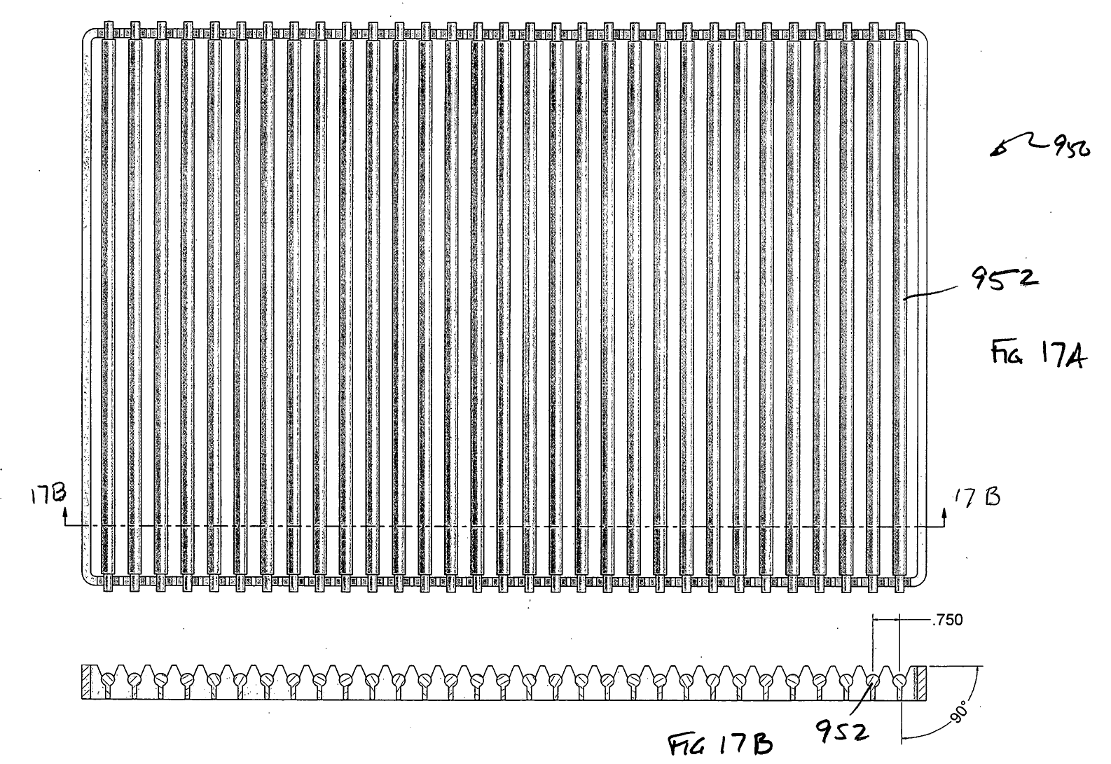

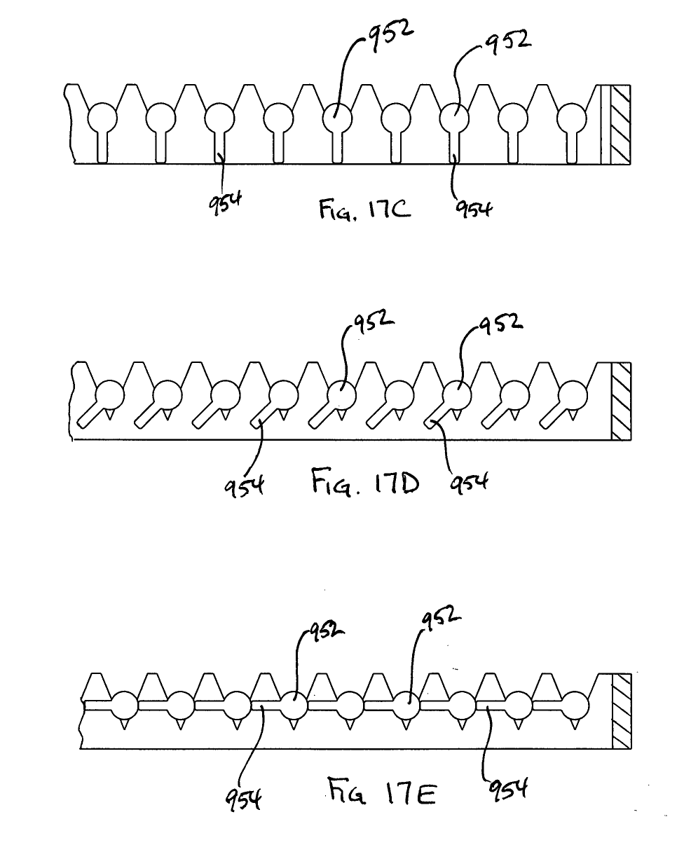

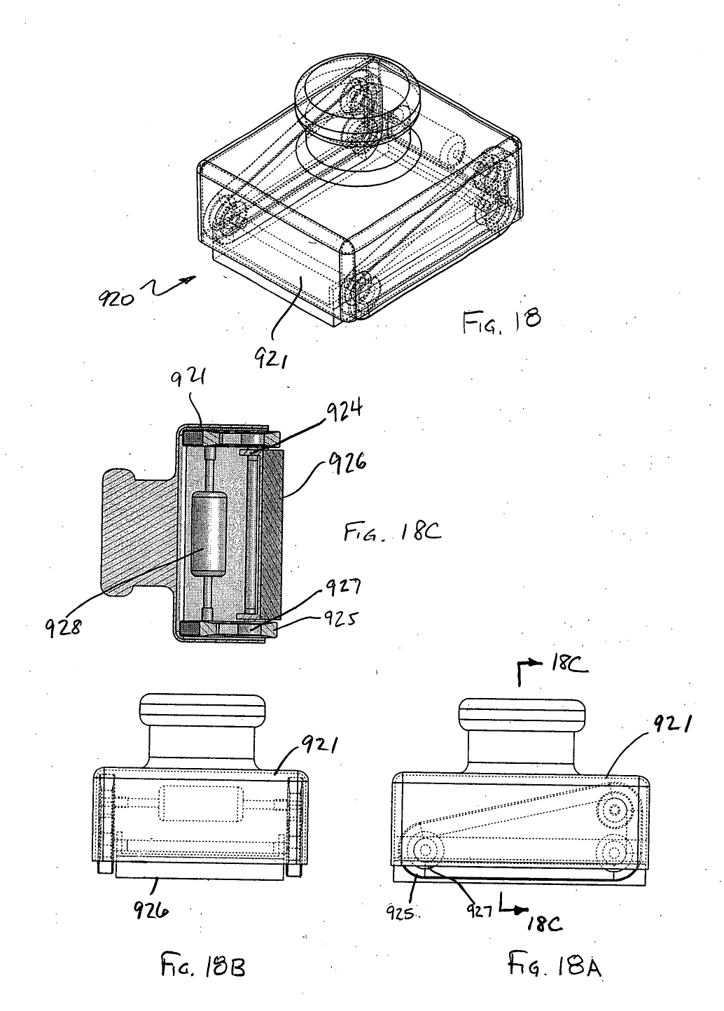

FIG. 4B is a top view of the grill top of FIG. 5A.

FIG. 4C is a front view of the grill top of FIG. 5A.

FIG. 5D is a side view of the grill top of FIG. 5A.

FIG. 5E is an isometric view of the grill top of FIG. 5A illustrating the grill rods being slidably removed from the frame.

FIG. 6A is an isometric view of an alternate embodiment of a grill top according to the present invention.

FIG. 6B is a top view of the grill top of FIG. 6A.

FIG. 6C is a front view of the grill top of FIG. 6A.

FIG. 7A is an isometric view of an alternate embodiment of a grill top according to the present invention with the grill rods shown removed from the grill frame.

FIG. 7B is a top view of the grill top of FIG. 7A.

FIG. 7C is a front view of the grill top of FIG. 7A.

FIG. 8A is an isometric view of an alternate embodiment of a grill top according to the present invention

FIG. 8B is a top view of the grill top of FIG. 8A.

FIG. 8C is a front view of the grill top of FIG. 8A.

FIG. 9A is an isometric view of an alternate embodiment of a grill top according to the present invention.

FIG. 9B is a top view of the grill top of FIG. 9A.

FIG. 9C is a front view of the grill top of FIG. 9A.

FIG. 9D is a side view of the grill top of FIG. 9A.

FIG. 9E is an isometric view of the grill top of FIG. 9A illustrating the grill rods removed from the frame.

FIG. 10A is a top view of an alternate embodiment of a grill top according to the present invention.

FIG. 10B is a side cross-sectional view of the grill top of FIG. 10A taken along lines 10B-10B.

FIG. 11 is an isometric view of an alternate embodiment of,a grill top according to the present invention.

FIG. 12A is a partial side view of a rod from the embodiment of FIG. 11.

FIG. 12B is a partial cross-sectional view of the rod of FIG. 12A taken along lines 12B-12B.

FIG. 13 is an isometric view of an alternate embodiment of a grill top according to the present invention.

FIG. 14A is a partial side view of a rod from the embodiment of FIG. 13.

FIG. 14B is a partial cross-sectional view of the rod of FIG. 14A taken along lines 14B-14B.

FIG. 15A is a front view of a cleaning device according to an alternate embodiment of the invention for cleaning the rods.

FIGS. 15B and 15C are top views of the cleaning device of FIG. 15A illustrating the rod being inserted into the device.

FIG. 16A is a top view of a hand-held cleaning device according to an alternate embodiment of the invention for cleaning the grill top.

FIG. 16B is a side cross-sectional view of device of FIG. 16A.

FIG. 17A is a top view of an alternate embodiment of a grill top according to the present invention.

FIG. 17B is a side cross-sectional view of the grill top of FIG. 17A taken along lines 17B-17B.

FIGS. 17C, 17D and 17E are enlarged partial side cross-sectional views illustrating the louvers in open, partially-open and closed positions, respectively.

FIG. 18 is an isometric view of an alternate embodiment of a cleaning device according to the present invention.

FIG. 18A is side view of the cleaning device of FIG. 18.

FIG. 18B is front view of the cleaning device of FIG. 18.

FIG. 18C is a cross-sectional view of the rod of FIG. 18A taken along lines 18C-18C.

### DETAILED DESCRIPTION OF THE INVENTION

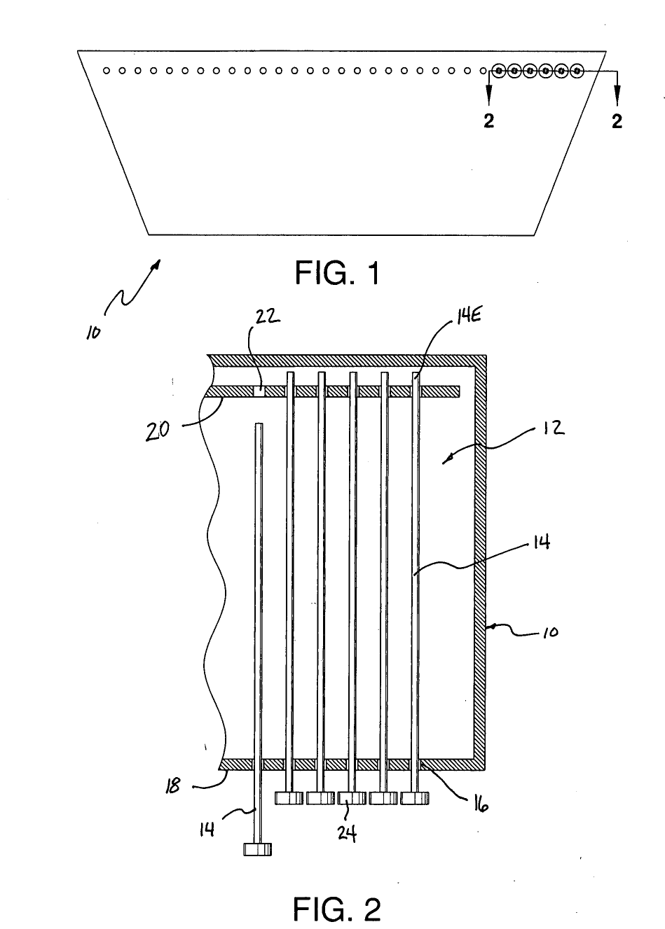

Referring now to the drawings, various currently preferred embodiments of the invention are depicted, wherein like reference numerals refer to similar items throughout the views. FIG. 1 illustrates a schematic side view and FIG. 2 a schematic partial top view of a grill 10 with a grill top 12 according to one embodiment the invention.

The grill top 12 includes a series of individual grill rods 14 which are independently separable from one another. As shown in the figures, the grill 10 includes a series of openings 16 formed in a side wall 18 of the grill 10. The holes 16 are sized to be slightly larger than the diameter of the rods 14 such that the rods 14 can be inserted into the holes 16. The rods 14 are sufficiently long so as to extend across the cooking area with their free ends 14E engaging with a frame support 20 on the opposite side. In the illustrated embodiment, the free end 14E of each rod 14 engages with a corresponding hole 22 formed in the frame support 20. However, it should be readily apparent that the free ends of the rods can be supported in a variety of ways, such as resting in notches formed in the frame support or extending through holes formed in the opposite side of the grill.

The spacings of the holes 16, 22 are preferably equal and designed to provide conventional spacing between rods, e.g., approximately 0.75 inches. However, it is also contemplated that different hole spacings may be used to provide the grill top with different rod spacings in different areas.

Each rod 14 preferably includes a handle 24 formed on the end opposite the free end. The handle 24 may be made from the same material as the rod 14, or may be made from a different material, such as a material that reduces conduction of heat like rubber.

The rods 14 can be made from any material suitable for use in forming a grill top, including metal (e.g., stainless steel, cast iron, aluminum), ceramic or porcelain. Other materials can also be used. In one embodiment, the rods have a diameter of approximately 0.25 inches, however any suitable size (and shape) may be used. For example, the rods may be square or triangular in cross-section.

As shown in FIG. 2, each rod 14 is preferably individually separable from the other rods and capable of being removed from the grill 10 so as to facilitate cleaning of the rod. For example, rod 14A is shown being slid out of the holes 16, 22. Once removed, the rod can be cleaned in a variety of different ways, such as by placing the rod 14 into a dishwasher. Alternately, as will be discussed below, the rod could be cleaned by running the rod through a separate cleaning device.

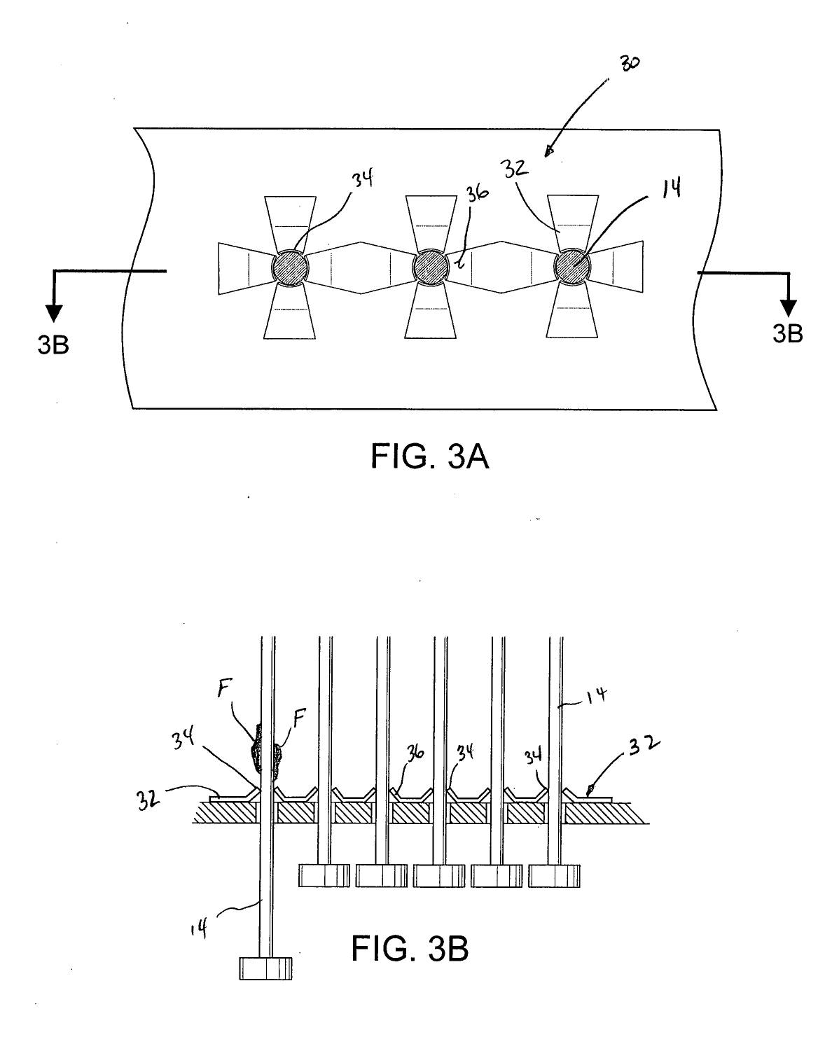

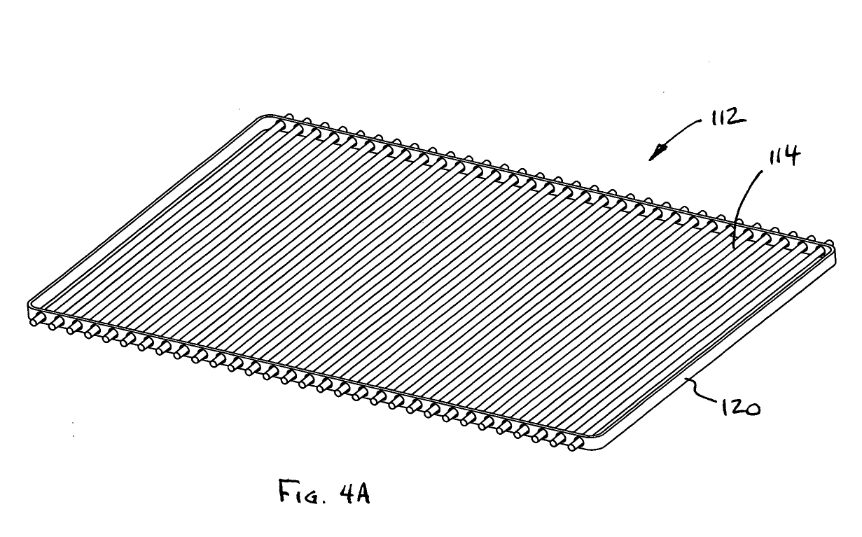

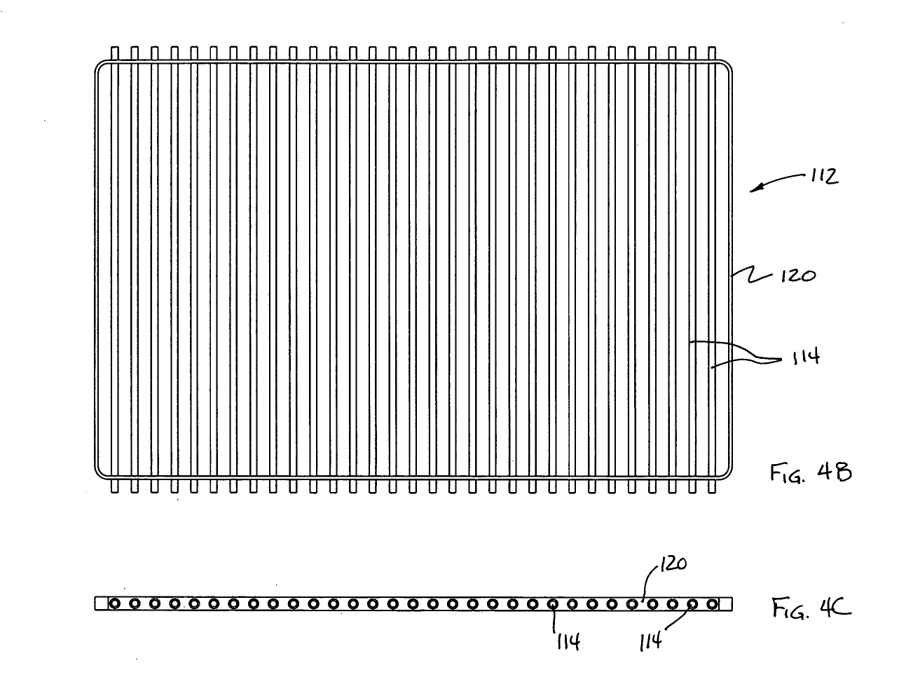

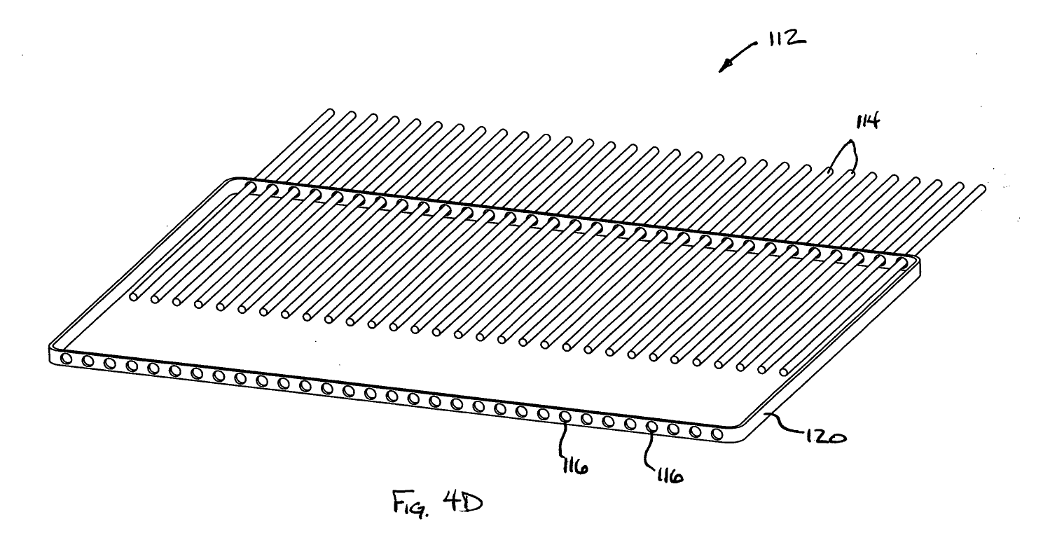

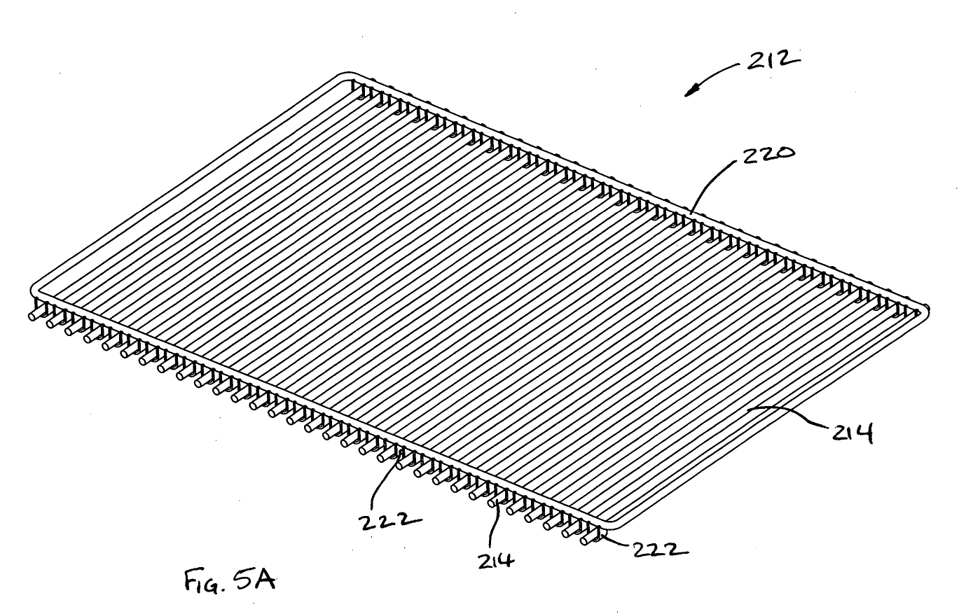

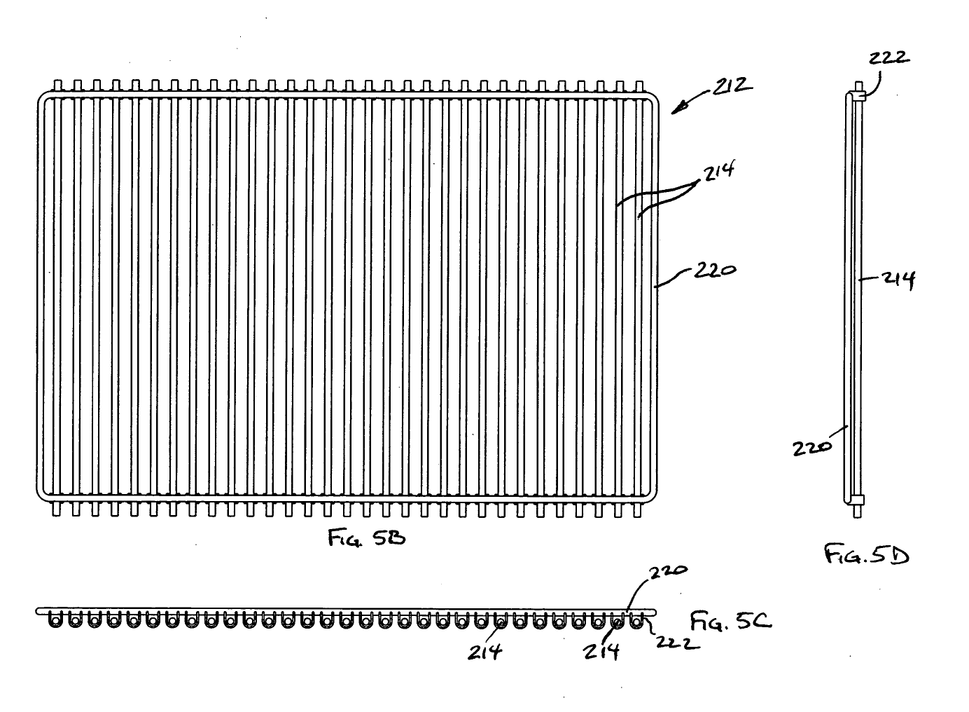

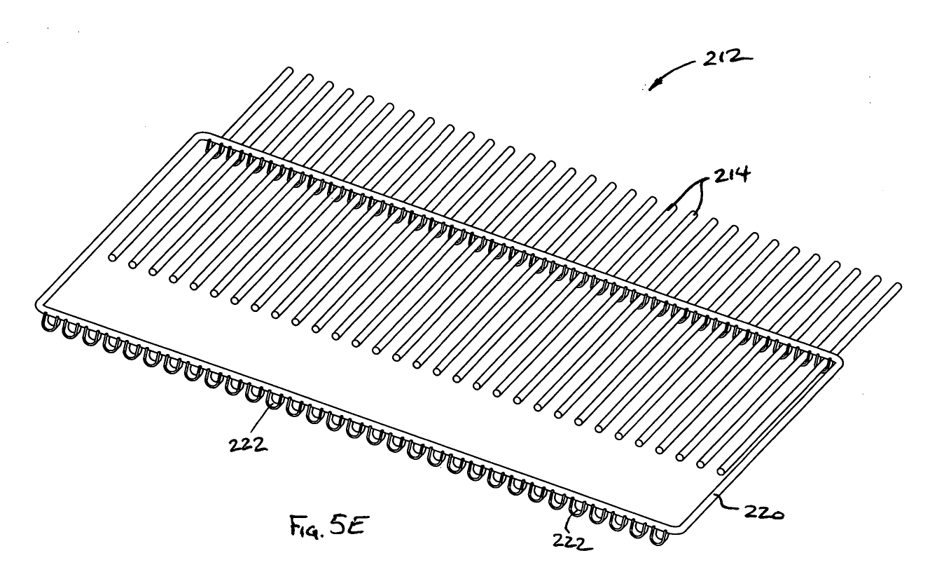

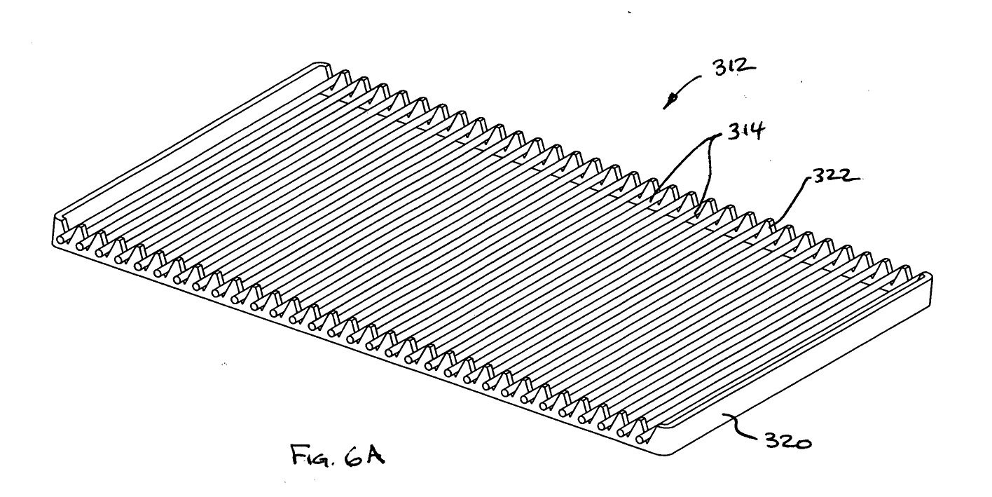

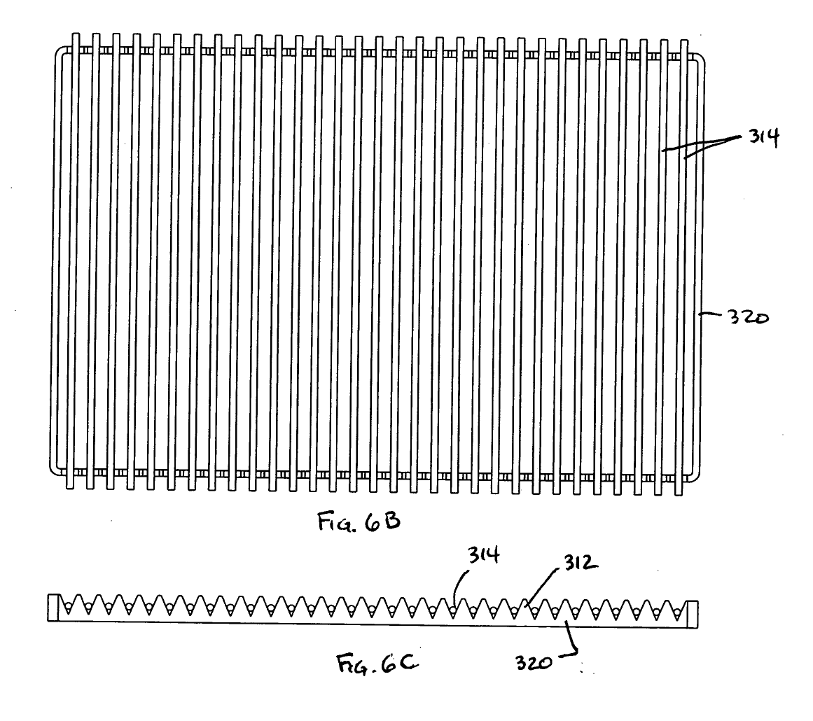

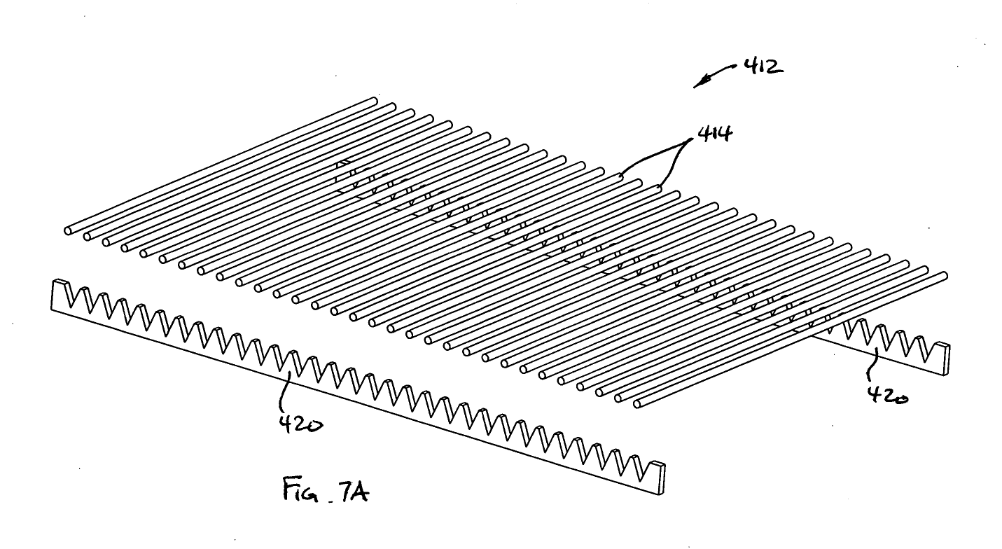

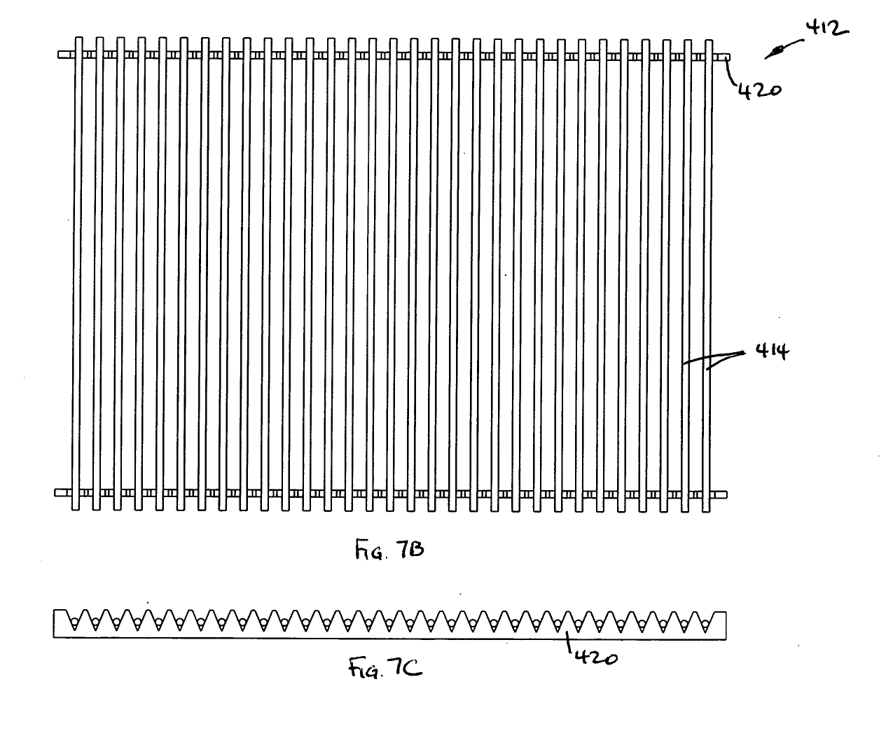

Referring to FIGS. 3A and 3B, one embodiment of a cleaning device 30 is shown. In this embodiment, scrapers 32 are mounted around each rod 14. The scrapers 32 in the illustrated embodiment are each shaped so as to have an edge 34 that preferably conforms to a portion of the contour of the rod 14. As shown, since the rods are cylindrical in shape, the scrapers each preferably have an edge 34 that has an arcuate shape that is less than one quarter of the circumference. As such, four scrapers 32 per rod would, in combination, provide an effective scraping surface covering approximately the entire circumference of the rod 14 as depicted in FIG. 3A. Of course, if the scrapers 32 have an edge defining a larger portion of the circumference of the rod (e.g., one half), less scrapers 32 would be needed. It should be readily apparent that if the rods have a different cross-sectional shape, a different shape or the edge and arrangement of the scrapers would be needed.

The scrapers 32 are preferably positioned such that the edges engage with and scrape along the circumference of the rod 14. As shown in FIG. 3B, as the rod 14 is pulled out, the scrapers 32 scrape caked on food (identified as F in FIG. 3B). To facilitate the scraping, the scrapers 32 are preferably formed from spring steel or similar strong, yet slightly flexible material that can withstand high temperatures. In the illustrated embodiment, the scrapers 32 include a bent leg 36, the end of which includes the edge 34. In this configuration, the bend in the scraper 34 provides a tight fit about the rod 14. Since the rod 14 is inserted in the direction of the bend, the bent leg 36 will flex as the rod 14 is inserted, yet maintain the shape of the scraper when the rod is pulled out.

This embodiment of the invention provides a quick mechanism for cleaning the rods 14 after use. The user simply pulls a rod outward and the scrapers remove the caked on food. The rod can then be reinserted. It is contemplated that the rods may be designed so as to inhibit their complete removal. This can be done by adding a stop or shoulder near the free end that cannot readily fit past the scrapers. Also, it is possible to attach several, if not all, of the rods together to a single handle allowing a user to pull all of the rods through the scrapers at the same time.

While the scrapers 34 are shown as separate components, it is also contemplated that the scrapers can be interconnected for easy attachment to the grill wall. Also, the scrapers can be designed to be replaceable.

The above discussion has focused on an embodiment of the invention in which that the grill top 12 is attached to the grill 10 such that the rods 14 extend out of holes 16 formed in the side 18. It is also contemplated that the grill top 12 can be constructed such that it can be placed down into or onto the grill 10 like conventional grill tops. In this embodiment, the grill top is supported by brackets or other supports mounted to the grill 10 in a conventional manner.

Referring now to FIGS. 4A-4D, one embodiment of a removable grill top 112 is shown. In this embodiment, the grill top 112 includes a grill frame 120 which is preferably designed to extend across the heating area of the grill during use. In the illustrated embodiment the grill frame 120 is substantially rectangular. The frame is preferably made from a heat resistant material, such as stainless steel, iron, ceramic or porcelain. Other types of materials can be used. The cross-sectional shape of the individual frame members can have any suitable shape that provides sufficient support for grill rods 114.

The grill top 112 includes a plurality of individual grill rods 114. The grill rods 114 are similar to the grill rods 14 discussed above. The grill rods in the embodiment illustrated in FIG. 4A are cylindrical in shape. Other shapes, of course, are possible. The rods 114 extend through holes 116 formed in the frame 120. The holes 116 are similar to the holes 16 described above and are slightly larger in shape than the size of the rods 114. As shown, there are holes formed on opposite sides of the frame 120 such that one end of the rod 114 extends through one hole and the other end extends through the other hole. As discussed above, the rods may include handles (not shown) at one end to limit the passage of the rod into the hole and provide an easy way to remove the rods for cleaning. Other mechanisms can be used to limit the movement of the rods within the holes.

In the illustrated embodiment, the frame 120 includes two spaced apart side frames 121. The ends of the side frames are preferably connected by lateral frames 123 so as to form a rigid box structure. The frame 120 is preferably made stainless steel with a thickness of about 0.125 inches and a cross-sectional height of about 0.5 inches. The frame has an overall shape of about 16 inches and about 24 inches. The hole spacings are about 0.75 inches on center.

FIG. 4D illustrates that rods 114 in a state of partial removal with the rods still engaged with one hole but one free end removed from the other hole.

Referring now to FIGS. 5A-5D, a further embodiment of the removable frame top is shown. In this embodiment the grill top 212 includes a frame 220 and a plurality of rods 214, each rod again being removable from the frame 220. The primary difference between this embodiment and the prior embodiment is that the frame 220 does not include holes. Instead, the frame has a series of rod support 222 that are attached to the frame 220 and form cradles or support seats for the rods 214. In the illustrated embodiment, the supports are substantially U-shaped and have an inner shape that complements the shape of the rod 214, at least at portions of the rod 214 that are intended to seat on the support. For example, if the rod has a round cross section at its ends, the supports 222 preferably have a semicircular inner surface so that the rods seat onto the inner surface of the supports.

However, if it is desired that rotation of the rods be inhibited when mounted to the frame, that the ends of the rods may be formed with a non-circular cross-section (e.g., square). The support 222 would have a inner surface shape that complements the end of the rod so as to prevent rotation (e.g., a square shape).

The supports 222 are preferably fixedly attached to the frame 220, such as by welding, so as to form an integral unit. The supports are preferably made from the same material as the frame 220.

Referring to FIG. 6A-6C, another embodiment of the removable grill top 312 is shown. In this embodiment, the frame 320 includes V-shaped notches 322 to support the rods 314. The shape of the notch permits the rod 314 to roll within the notch. Of course, the shape of the notches 322 can be other than V-shaped, such as U-shaped.

FIGS. 7A-7C show a similar embodiment of the grill top 412, except that the frame 420 is not designed to be removable from the grill 10. Instead, the frame 420 is formed from two separate frame members 420 that are mounted to the inside of the grill 10 (not shown).

FIGS. 8A-8C show a variation of the grill top in the embodiment of the invention shown in FIGS. 6A-6C. In this embodiment, the frame includes a lock 350 to prevent or inhibit removal of the rods 314. Any suitable lock can be used. In the illustrated embodiment, the lock includes a pivotable locking frame that is hinged or pivotably attached to the frame 320. When the locking frame is pivoted down (as shown on the left side of FIG. 8A and the bottom of FIG. 8B), the rod ends can be removed from the frame 320. To lock the device, the locking frame 350 is rotated up (as shown on the right side of FIG. 8A and the top of FIG. 8B). This position prevents the ends of the rods from being removed from the frame 320. FIGS. 9A-9E shows a similar locking mechanism 450 when used with the embodiment of the invention shown in FIGS. 7A-7C.

A further variation of the present invention is shown in FIGS. 10A and 10B. In this embodiment, at least the ends of the rods 514 are hollow so as to form a recess 515. The frame 520 includes two frame members 522 which each have rod supports 524 that extend from one side of the frame member 522. The supports 524 include a plug with a shape designed to engage with the recess 515 in the rod to secure the rod 514 to the frame 520. When all the rods 515 are attached to the frame 520, the grill top 512 is a complete unit. Preferably the recesses are circular in diameter and the supports 524 are cylinders that slidingly engage with the recesses. However, a variety of other complementary shapes can be used in the present invention.

FIG. 11 illustrates another embodiment of the invention where the rod 614 includes removable ends 616. This allows a hollow rod center portion 618 to be used that is larger and/or different in shape than the ends 616. The removable ends 616 are attached to the center portion as described in the prior embodiment. Once attached to the center portion, the other portion of the end 616 engages with the frame as in any of the various embodiments described above. FIGS. 12A and 12B illustrate one form of rod 614 according to this embodiment of the invention.

It is also envisioned that the rods in the present invention can be formed with holes for providing heat passage or, more preferably, for cooking enhancement. Referring to FIGS. 13 and 14A and B, the rods 714 are shown as having a series of holes 730 formed in the body of the rod. The holes 730 can be formed on one side or opposite sides of the rod depending on the desired use of the rod.

For example, if the holes are formed along the upper surface of the rods, with no holes on the bottom, it is possible to fill the rods with a liquid, such as water or a flavor enhancing liquid like steak sauce, mesquite flavoring, barbeque sauce, etc. Thus, during cooking, when the rod heats up, the heat causes the liquid inside the rod to evaporate into a gas. The moist gas rises through the holes and enters into the item being cooked or into the chamber formed inside the grill cover. This greatly enhances the cooking of the foods. To fill the rod, at least one end of the rod preferably can be opened as described previously.

It is also contemplated that, instead of a liquid, a solid can be inserted into the rod, such as a flavor enhancing stick. For example, the flavor stick may be made from or include mesquite or hickory. As the rod heats up, the flavoring from the hickory or mesquite enters the food or the cooking chamber, thereby enhancing the flavor of the food. In this embodiment, the holes can be formed on both sides of the rod as shown in FIG. 14B.

As discussed above, there are various ways to clean the rods of the grill tops described above. Another cleaning device 800 is shown in FIG. 15A. The cleaner 800 includes a frame 802 onto which is mounted scrapers or scouring pads 804, such as ScotchBrite® pads. (ScotchBrite® is a registered trademark of the 3M company.) The pads 804 are preferably positioned so as to contact substantially the entire circumference of the rods 14. In the illustrated embodiment, the pads 804 have an arcuate shape and sized so as to cover approximately one third of the rod 14 circumference. Other shapes and sizes are, of course possible. The pads may be attached to the frame 802 through supports 806. The pads 804 are preferably replaceable such that the pads can be changed when the pads wear down or become clogged with debris. FIGS. 15B and 15C illustrate a rod 12 with caked on food being inserted into the cleaning device. As the rod passes through, the scouring pads scrape off the food that is on the rod.

It should be readily apparent that, instead of the scouring pads 804, it is also possible to mount a scraper similar to the scraper described with respect to embodiment illustrated in FIGS. 3A and 3B.

Referring to FIGS. 16A and 16B, an embodiment of the cleaning device is shown for use on the grill top. In this embodiment, the cleaning device 900 is a handheld device that has a handle 902 mounted to a base 904. A cleaning pad 906, such as a scouring pad, is mounted to the bottom of the base 904. One or more drive wheels 908 are attached to the base 904. The mounting and size of the wheels 908 is designed to position the scouring pad 906 in contact with the rods 12. A motor (not shown) is preferably mounted to the base 904 and connected to one or more of the drive wheels such that activation of the motor causes the drive wheels 908 to rotate. The drive wheels are preferably made from a material that produces a sufficient degree of friction between the rods 12 and the drive wheels 908 such that the drive wheels 908 cause the rods to rotate. One preferably material is urethane. If the cleaning device 900 is intended to be used when the rods are hot, then the material selected such be able to withstand the typically level of heat to which the rods are exposed.

As the drive wheels 908 are rotated by the motor, their contact with the rods causes the rods to rotate as well. Since the rods are in contact with the scouring pad 906, the rotation of the rods causes scouring of the rods 12 by the scouring pad, thus effecting cleaning of the rods.

The motor can be powered by any suitable power source such as AC power (such as from an outlet) or DC power (such as from batteries mounted in the handle or the base.)

An alternate embodiment of the cleaning devise is shown in FIGS. 18 and 18A-18C. In this embodiment, the cleaning device 920 includes a housing 921 with a handle 922 mounted to a base 924. A cleaning pad 926, such as a scouring pad, is mounted to the bottom of the base 924.

One or more drive belts 925 are rotatably mounted to the housing 921. Preferably there are two drive belts 925 mounted on either side of the housing. The drive belts 925 project out from the bottom of the base 924 on either side of the pad 926 at a position suitable for engaging with the rods of the grill. Each drive belt is mounted about at least two wheels 927 rotatably attached to the base 924. As shown, a motor 928 is mounted to the housing and engaged with at least one wheel for rotatably driving the belt 925. Preferably, the motor is position between the two drive belts and is configured to engage one wheel for each belt. As in the previous embodiment, the motor can be powered by any suitable power source such as AC or DC power. The belts are preferably made from a material suitable for frictionally engaging with the rods.

A further variation of the invention is shown in FIGS. 17A-17E. This embodiment of the invention includes a louver system 950 as part of the rods 952 for providing directional control over heat and/or smoke. More particularly, the rods 952 preferably include an eccentric flap 954 that extend from the rod 952. As such, rotation of the rod 952 determines the orientation of the flap 954 (see FIGS. 17C-17E). By placing the flap in the proper orientation, the heat from the heat source can be directed in a desired manner. When the rod is completely rotated, the flaps or louvers 954 block the space between the rods, thus effectively blocking or reducing the passage of heat current through the rods to the food being cooked (see FIG. 17E).

This embodiment is particularly beneficial for a smoker. The louvers permit control over the directional flow of the smoke.

While the present invention has been described with respect to various preferred embodiments, it should be readily apparent to those skilled in the art that a variety of modifications are possible in light of the teachings provided herein.

What is claimed is:

1. A grill top for a grill, the grill including a wall and an open cooking area, the grill top adapted to be mounted to the grill such that the grill top extends across at least a portion of the grilling area, the grill top comprising:
a grill frame having at least two opposed side frames; and
a plurality of grill rods, each grill rod including first and second opposed ends, the first end of each rod being rotatably mounted to one side frame and the second end being rotatably mounted to the other side frame such that each rod is rotatable relative to each adjacent rod and the grill frame.

2. A grill top according to claim 1, wherein the rods are removable relative to the grill frame such that at least one end of the rods can be moved out of engagement with an associated side frame.

3. A grill top according to claim 1, wherein the rods are slidable relative to the grill frame such that at least one end of the rods can be slid out of engagement with an associated side frame.

4. A grill top according to claim 3, wherein the rods include a handle to facilitate sliding of the rod relative to the grill frame.

5. A grill top according to claim 4, wherein the grill frame is formed integral with a grill.

6. A grill top according to claim 5, wherein the grill includes a first side, and wherein the grill includes a plurality of holes spaced laterally apart from one another, and wherein the rotatable mounting of each rod is provided by an end of the rod positioned within the hole such that the rod end can rotate within the hole.

7. A grill top according to claim 6, wherein at least one scraper is mounted to the grill adjacent to each rod and wherein the lateral sliding of the rod causes the rod to slide past the scraper thereby scraping food particles off the rod.

8. A grill top according to claim 1, wherein the rods are hollow, and at least one end includes a removable cap which permits access to the inside of the rod.

9. A grill top according to claim 8, wherein the rods include a plurality of holes and wherein the rods are adapted to removably receive flavor slicks which are designed to emit a gas out of the holes during cooking.

10. A grill top for a grill, the grill top comprising:
a grill frame having at least first and second side frames spaced apart from one another, and a plurality of rod supports formed on each side frame, the rod supports being spaced apart from one another; and
a plurality of grill rods, each grill rod including first and second opposed ends, the first end of each rod being rotatably supported by a rod support on the first side frame, and the second end of each rod being rotatably supported by a rod support on the second side frame, each rod being rotatable relative to an adjacent rod and the grill frame.

11. A grill top according to claim 10, wherein the rod supports comprise holes formed in the side frames, and wherein there are two lateral frames, each lateral frame connecting to one end of each side frame.

12. A grill top according to claim 10, wherein the rod supports comprise U-shaped brackets attached to the side frames, each rod sitting in two U-shaped brackets, and wherein there are two lateral frames, each lateral frame connecting to one end of each side frame.

13. A grill top according to claim 10, wherein the rod supports comprise notches formed in the top of the side frames, each rod sitting in a corresponding notch in each side frame.

14. A grill top according to claim 13, further comprising locking frame pivotally attached to the frame, the locking frame having a closed position where the locking frame prevents an end of each of the rods from being removed from its corresponding notch, thereby locking the rod end into the side frame, the locking frame have an open position wherein the locking frame is pivoted to a location which permits an end of each rod to be removed from is corresponding notch.

15. A grill top according to claim 13, wherein each rod includes a removable cap at each end, each cap engaged with a recess formed in the end of the rod, each cap including a distal end adapted to rotatably seat within a notch.

16. A grill top according to claim 15, wherein the rods are hollow, the removable cap permitting access to the inside of the rod, and wherein the rods include a plurality of holes.

17. A grill top according to claim 16, further comprising flavor slicks removably received in the grill rods, the flavor sticks designed to emit a gas out of the holes during cooking.

18. A grill top according to claim 10, wherein the rod supports comprise a plurality of plugs projecting from one surface of each side frame, each plug having a shape designed to engage with a recess formed in an end of a rod to secure the rod to the side frame.

19. A grill top according to claim 10, wherein a plurality of the rods include a fin projecting along at least a portion of the length of the rod, the fin acting as a louver to provide control over the passage of air and heat between adjacent rods.

20. A grill top for a grill, the grill top comprising:
a grill frame having at least first and second side frames spaced apart from one another, and a plurality of rod supports formed on each side frame, the rod supports being spaced apart from one another; and
a plurality of grill rods, each grill rod including first and second opposed ends, the first end of each rod being rotatably supported by a rod support on the first side frame, and the second end of each rod being rotatably supported by a rod support on the second side frame, each rod being rotatable relative to an adjacent rod and the grill frame; and
a flavor enhancer within each rod, the flavor enhancer adapted to permeate from the rod during cooking.
